(19) United States
(12) Patent Application Publication
(10) Pub. No.: US 2008/0279147 A1
(43) Pub. Date: Nov. 13, 2008

(54) Spectrum auction and sharing on wireless clients

(75) Inventors: Amer A. Hassan, Kirkland, WA (US); Thomas W. Kuehnel, Seattle, WA (US); Deyun Wu, Issaquah, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/899,350

(22) Filed: Sep. 5, 2007

Related U.S. Application Data
(60) Provisional application No. 60/928,113, filed on May 8, 2007.

(51) Int. Cl. H04Q 7/36

(52) U.S. Cl. 370/330

(57) ABSTRACT

Methods and apparatus to enable spectrum auctioning, allowing a user to gain access to otherwise unavailable spectrum is disclosed. Spectrum providers may have the exclusive rights to the spectrum, but these providers can allow other users to access the spectrum in certain situations, for example, limited time use without restrictions, or use based on interference constraints. Software Defined Radio (SDR) may be employed to allow a wireless user to bid for spectrum usage when a wireless network is otherwise unavailable to them.

### CROSS REFERENCE TO RELATED APPLICATION

This application claims the benefit of U.S. Provisional Patent Application Ser. No. 60/928,113, filed May 8, 2007, which is hereby incorporated by reference in its entirety.

### BACKGROUND

Many mobile computing devices support wireless communications so that users may connect those devices to networks without constraints on mobility imposed by wired connections. However, wireless communications require access to spectrum and sometimes this access is not readily available. There is a growing commercial need to make more efficient use of wireless spectrum controlled by exclusive owners and/or licensees to allow users to access spectrum for wireless communication.

### SUMMARY

The present invention relates to methods for using Software Defined Radio technology to enable spectrum auctioning, allowing a user to gain access to otherwise unavailable spectrum. Owners and/or licensees of the spectrum may have the exclusive rights to the spectrum, but these owners and/or licensees can allow other users to access the spectrum in certain situations, for example, limited time use without restrictions, or use based on interference constraints. To increase the effectiveness of wireless communication, and therefore the utility of mobile devices that communicate wirelessly, groups of users (e.g., a network or multiple networks) may use Software Defined Radio (SDR) on their mobile devices to bid for spectrum usage when a wireless network is otherwise unavailable to them.

In one embodiment, a method for accessing a spectrum is provided. The method includes sending a request for access to a spectrum and receiving an offer to access a spectrum. The access is based on one or more constraints. The method further includes accepting or rejecting the offer.

In another embodiment, a method for providing access to a spectrum is disclosed. The method includes receiving a request for access to a spectrum from a user; determining a suitable spectrum to offer; and sending an auction bid to a spectrum provider. The method further includes receiving an offer to access a spectrum from the spectrum provider. The access is based on one or more constraints. The method further includes sending the offer to the user; and receiving an acceptance or rejection of the offer from the user.

In still another embodiment, an apparatus for operating a wireless computing device is provided. The apparatus includes a first circuit configurable to send a request for access to a spectrum and a second circuit configurable to receive an offer to access a spectrum. The access is based on one or more constraints. The apparatus also includes a processor configurable to process an acceptance, a rejection or a counter-offer.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1a is a flowchart of one illustrative process according to an embodiment of the invention;

FIG. 1b is a flowchart of another illustrative process according to an embodiment of the invention;

FIG. 2 is a flowchart of another illustrative process according to an embodiment of the invention;

FIG. 3 is a diagram of an illustrative computer system environment in which embodiments of the invention may be implemented; and

FIG. 4 is an exemplary computing device that may be used in accordance with embodiments of the invention.

### DETAILED DESCRIPTION

Aspects of this invention relate to processes and apparatuses for spectrum auctioning, allowing a user or a group of users (e.g., a network or multiple networks) to bid for spectrum usage, as desired. According to aspects of the invention, the method can be implemented, at least in part, by Software Defined Radio (SDR). Various reasons exist for a user or a group of users to require obtaining spectrum, as will be discussed below. Suffice it to say for now that aspects of the present invention are directed to processes allowing a user to obtain access to a wireless spectrum through spectrum auctioning techniques.

Although the procedure described herein can be implemented in software, such as with software defined radio, the present invention is not limited in this regard as other arrangements for auctioning spectrum may be employed. Also, the auctioning process may be transparent to the user, except upon exchange of consideration for usage.

There is a growing commercial need in making more efficient use of wireless spectrum by shifting from the exclusive (centralized) spectrum ownership models to the more flexible spectrum usage. In this regard, the owners and/or licensees of the spectrum may have the exclusive rights to the spectrum, but the inventors have found that these providers can allow other users to access the spectrum in one of two situations: 1) limited time use without restrictions, and/or 2) use based on interference constraints.

Technology is evolving to allow for a more flexible use of the spectrum. SDR allows for variation in spectrum, power, bandwidth, modulation, etc. SDR with auctioning can be used to reuse the operating system (OS) modules to transmit and receive in different bands. The 3650 MHz band used in the US is an example where SDR can be used whereby SDR can be used to transmit 10 MHz 802.11a/g in those bands at higher power.

The inventors have found that oftentimes the most efficient and cost effective spectrum available may require that certain constraints be placed on using the spectrum. As an example, the leased spectrum may be limited to requiring a certain amount of interference and/or may be limited to a certain time period. The auctioned spectrum may require other constraints on usage, or no constraints on usage, as the present invention is not limited in this respect. Accordingly, in one embodiment, spectrum may be negotiated based on an incentive to allow the provider to give up spectrum in return for money, other spectrum or some other form of consideration. In another embodiment, spectrum access may be negotiated based on interference. In one embodiment, usage is based on maximum interference allowed to the provider of the spectrum.

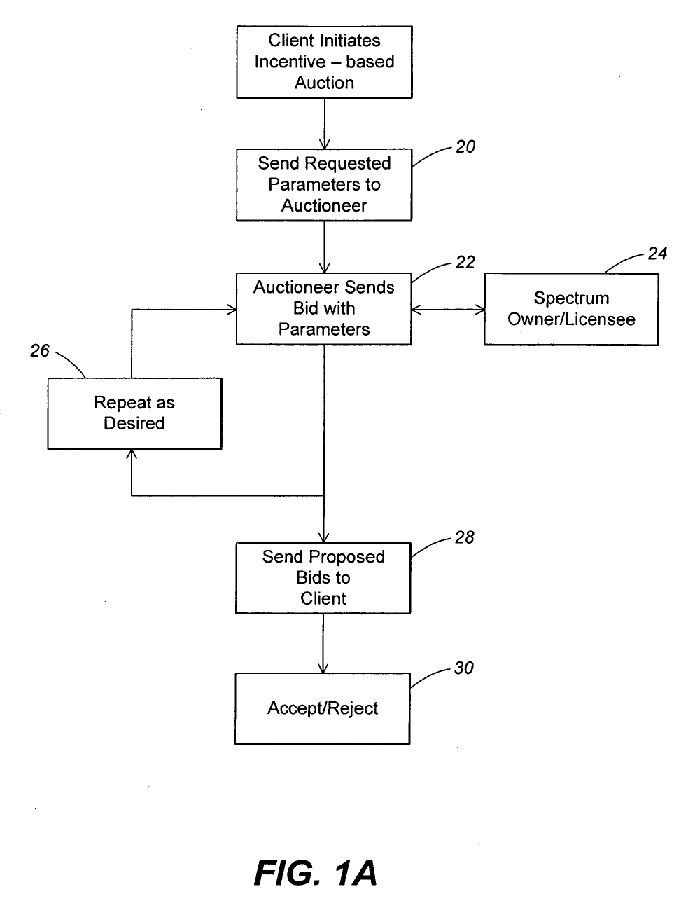

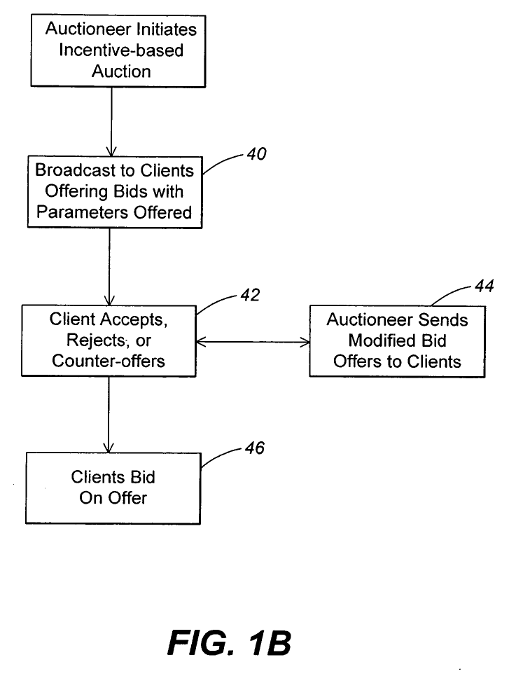

Incentive-based time-limited auctioning will now be described with reference to the flowcharts of FIGS. 1a and 1b. In these embodiments, the auctioning may be initiated by the client user or the auctioneer, as the present invention is not limited in this respect. With client initiated auctioning, shown in the flowchart of FIG. 1a, the request 20 may include certain parameters, such as one or more of the bandwidth required, the set of bands preferred, the mask properties desired, that the request is based on an incentive model and/or the times and durations of usage. Other parameters may be specified, as the present invention is not limited in this respect. In one embodiment, the request is sent via the client user's wireless device over a low data rate request over a common unlicensed band (e.g., usually in the 2.4 GHz, although other frequencies may be employed, as the present invention is not limited in this respect). Of course, the present invention is not limited in this respect, as the request may be made using a different device and/or may be sent over a non-wireless network for subsequent usage by the wireless device.

At this point, in one embodiment, having received the request, at 22, the auctioneer sends, as illustrated at 24, first round of bids with the parameters, including, for example: bandwidth offered, bands offered, mask properties available, and that the request is based on an incentive model and/or subject to times and/or durations of usage constraints. All spectrum providers receive this same information. In one embodiment, the auctioneer may send second, and if desired, subsequent n number of rounds of bids, as illustrated at 26. It should be appreciated that the auctioneer may be the owner or licensee or may be an independent auctioneer, as the present invention is not limited in this respect.

The proposed bids may then be sent back to the client user, as illustrated at 28, and the client may then make a choice of which bid to take, as illustrated at 30. In one embodiment, the client then would send data indicating an end of the auction. The client then enters the usage agreement with the chosen auctioneer.

With auctioneer initiated auctioning, as illustrated in the flowchart of FIG. 1b, the auctioneer, at 40, broadcasts an offering of bids with, in one embodiment, the following parameters: bandwidth available, bands available, mask properties offered, that the bid is based on an incentive model agreement and/or subject to times and/or durations of usage constraints.

In one embodiment, as illustrated at 42, the client may accept the bid or the client can counter offer, as illustrated at 44. For example, the client can accept the bandwidth offered or suggest accepting a lower bandwidth. Also the client can select the set of bands needed. The client can then also accept mask properties offered or suggest a less stringent option. The client may also accept the incentive model and the times and durations of usage constraints. Other clients receive all information and outbid last client bid with similar information, as illustrated at 46. The present invention is not limited to a single auctioneer initiating the auction and there may be more than one auctioning spectrum to the client user(s).

In one embodiment, joint auctioning may be provided. In this embodiment, when more spectrum is needed than can be offered by one entity, multiple auctioneers may enter the bidding process such that the auctioneers and/or client can package multiple offers to obtain the desired spectrum.

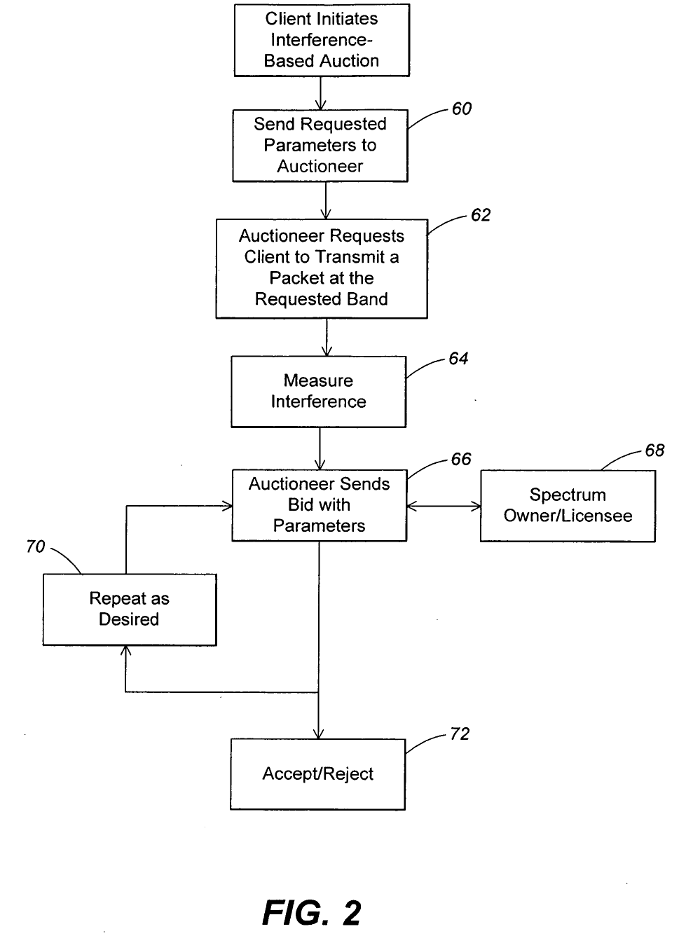

Interference-based auctioning will now be described. In these embodiments, the auctioning may be initiated by the client user or the auctioneer, as the present invention is not limited in this respect. With client initiated auctioning, as illustrated in the flowchart of FIG. 2, the request 60 may include certain parameters, such as one or more of the bandwidth required, the set of bands preferred, the mask properties desired, the physical location (if available), that the request is based on interference-based auctioning, and that a certain amount of interference is acceptable. Other parameters may be specified, as the present invention is not limited in this respect. In one embodiment, the request is sent via the client user's wireless device over a low data rate request over a common unlicensed band (e.g., usually in the 2.4 GHz, although other frequencies may be employed, as the present invention is not limited in this respect). Of course, the present invention is not limited in this respect, as the request may be made using a different device and/or may be sent over a non-wireless network for subsequent usage by the wireless device.

In one embodiment, after the request is made, the auctioneers request the client user to transmit a short packet at the requested band, as illustrated at 62. The auctioneer then measures the incremental interference at the auctioneer's receiver output, as illustrated at 64. At 66, the auctioneer may then send a first round of bids with one or more of the following pieces of information: bandwidth offered, bands offered and/or power allowed. At 68, all owners and/or licensees receive this same information. In one embodiment, the auctioneer may send second, and if desired, subsequent n number of rounds of bids, as illustrated at 70. An auction continues with power/bandwidth tradeoff with other auctioneers and the client user can then make a decision on offered parameters from all auctioneers, as illustrated at 72.

One method of controlled interference is to keep the interference level under some threshold. This can be done (on average) if the locations of the primary user receivers known as in the case of fixed wireless services.

In one embodiment, the auctioneers are trusted auctioneers, meaning that the auctioneer is authorized to control the band and/or the transaction and/or that communication between the client user and the auctioneer proceeds through suitable authorization techniques.

It should be appreciated that the constraints imposed on access to the spectrum may include a length of time use on the spectrum is permitted, an amount of interference acceptable, or both, as the present invention is not limited in this respect.

Illustrative examples of situations when spectrum auctioning may be employed will now be described.

In one illustrative example, a user may be in need of a network outside of his or her home network, such as may be the case when a user is traveling out of the country. In this regard, the user has his/her laptop with SDR and wants to access the local wireless network, whether it is WiFi or some other network protocol. Because the network is not one the user normally would need access to, the user typically would not be able to access the network, but nevertheless must somehow gain access. In one embodiment, software on the laptop allows the user access a Microsoft or third party's program, which would cause a communication link to access a local network. An auctioneer at the receiving end of the communication determines the best available option(s) (based, e.g., on the interference and/or the associated costs) for the user given the type of communication the user desires and/or needs (based, e.g., on the hardware and software installed on the user's computer).

In another illustrative embodiment, a user group may desire to set up a temporary network, e.g., to provide a network for a temporary office for multiple users. In one example, the user group desires to use its exclusive wireless network, which may not be based on WiFi, and desires to see if there is any network in the area that from which the group can utilize a spectrum. In this example, spectrum may only be available if the user group agrees to be within a certain interference limit and/or time constraints.

In another illustrative example, a wireless client A purchases temporary spectrum usage from wireless client B. In this example, wireless client A with a basic card can process multiple radios one by one or simultaneously if the corresponding software packages are installed. This makes the temporary usage of a radio band possible. For example, if a business customer (wireless client A) travels to a country and needs to use the WWAN service for a few days, wireless client A can purchase an SDR package from, e.g., Windows Live, which supports the WWAN service wireless client A desires, and purchases the spectrum from wireless client B for a desired time span. In this example, the user may be charged by a Carrier for this temporary data service usage.

In yet another example, wireless client A can obtain spectrum from wireless client B so that wireless client A can have access to a wider band. For such a situation, because wireless clients often need to share bandwidth with others, it may be important for wireless clients A and B to detect interferences and divide the bandwidth. The negotiation of spectrum can be free of charge, can be in exchange for spectrum, or in return for money. Other consideration may be use, as the present invention is not limited in this respect.

In another example, virtual Carriers may purchase spectrum from the real Carriers and then sub-lease to wireless clients for temporary usages. In this example, unlike the example described above, the exchange among individual wireless clients may not be reliable or sufficient. As such, virtual Carriers may see the value of providing temporary spectrum usages or providing both spectrum and data service usages to wireless clients. If a wireless client has subscribed to a data service plan already, or if a client only needs extra spectrum to do peer to peer data transmission, then only spectrum may be needed from the virtual Carrier. If a wireless client does not have a data service, both spectrum and data service are needed and may be obtained from the virtual Carrier.

Other situations, or combinations of situations, may be encountered requiring a wireless user to gain access to spectrum, as the present invention is not limited in this respect.

For all cases, the auction and sharing between the client and the auctioneer can be initiated by either party.

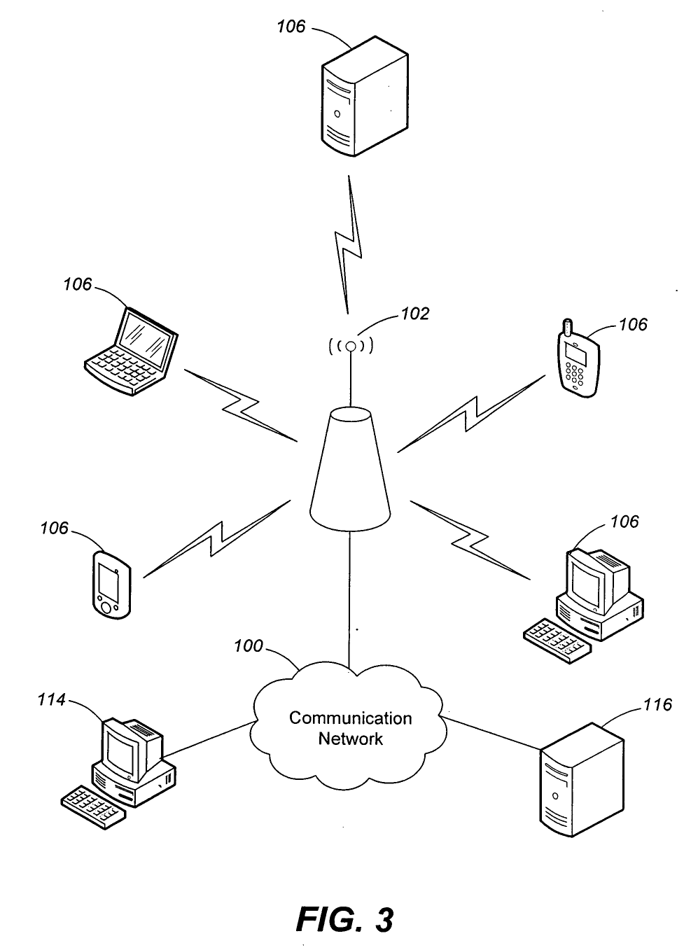

The aspects of the present invention described herein can be implemented on any of numerous computer system configurations and are not limited to any particular type of configuration. FIG. 3 illustrates one example of a computer system on which aspects of the invention can be implemented, although others are possible.

The computer system of FIG. 3 includes communication network 100, wireless access point 102, a plurality of wireless computing devices 106 configured to transmit and receive signals with the wireless access point 102, and wired computing devices 114 and 116. Communication network 100 can be any suitable communication medium or media for exchanging data between two or more computers (e.g., a server and a client), including the Internet. The wireless client devices can be any suitable computing device with wireless communication capabilities. Several exemplary wireless computing devices can be employed, including a laptop, a personal digital assistant, a smart phone, desktop computer, a server, and other devices, as the present invention is not limited in this respect. While FIG. 3 includes communication network 100 with wired devices 114 and 116, embodiments of the invention can be used in systems that do not include a wired network.

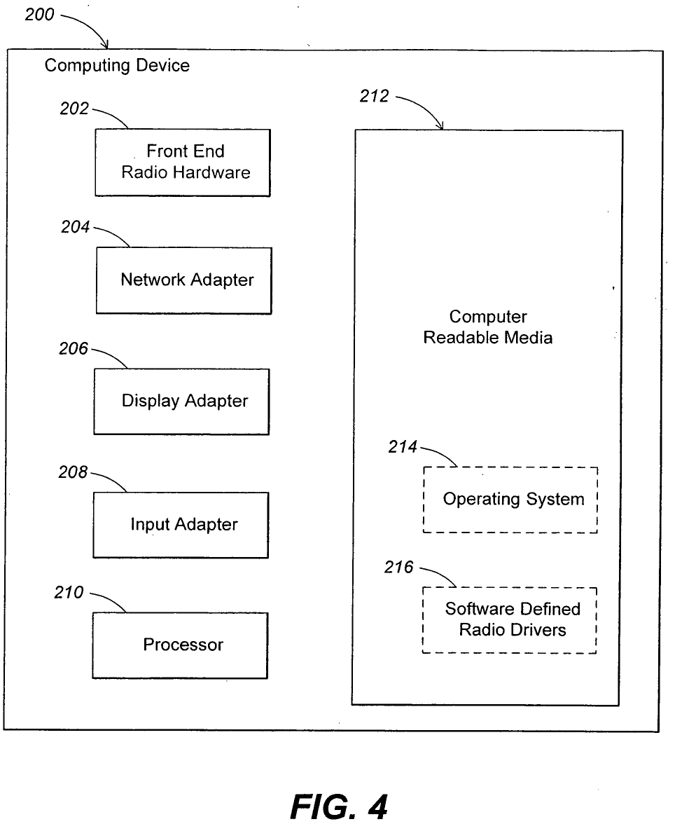

FIG. 4 schematically shows an illustrative computing device 200 that may be used in accordance with one or more embodiments of the invention. FIG. 4 is intended to be neither a depiction of necessary components for a computing device to operate with embodiments of the invention nor a comprehensive depiction. Computing device 200 comprises front end radio hardware 202 to communicate wirelessly, e.g., with wireless access point 102 or with other devices 108. Device 200 also comprises a network adapter 204 to communicate over a computer network using other (possibly non-wireless) methods, a display adapter 206 to display information to a user of the device, and an input adapter 208 to receive commands from the user. Device 200 further comprises computer-readable media 212 for storing data to be processed and/or instructions to be executed by a processor 210. Processor 210 enables processing of data and execution of instructions. The data and the instructions may be stored on the computer-readable media 212 and may, for example, enable communication between components of the computing device 200. The data and instructions may comprise an operating system 214 and software defined radio drivers 216. SDR drivers 216 may comprise data and instructions to carry out many functions typically done in hardware-implemented radios. The functions performed by drivers 216 may complement the functions of front end radio hardware 202, such that all desired functions may be performed by the combination of hardware and software.

Front end radio hardware 202 may be any suitable radio hardware performing any combination of functions. These functions may include modulation (i.e., mixing a data signal into a high frequency transmission signal), filtering (i.e., parsing data out of a received signal), analog-to-digital or digital-to-analog conversion, signal generation (i.e., transmitting the data), etc. Front end 202 may be implemented to perform a minimum of the required functions that need to be performed at the hardware level, with the remaining functions being implemented by SDR drivers 216. The present function is not limited to use with systems that decide the responsibilities of the hardware and software in any particular way. Front end 202 may comprise an antenna, a programmable radio-frequency waveform generator/decoder that spans a wide radio spectrum, an array of fast analog to digital converters, and/or serializers/de-serializers to convert analog data into computer-processable bytes and vice versa. A set of tunable analog filters may also be employed to comply with mandated spectrum masks. These hardware components are merely illustrative, as invention not limited to use on systems having any particular hardware.

SDR drivers 216, in addition to performing radio functions, may transmit control instructions to the tunable circuitry of front end 202 to customize the hardware of the front end 202 according to a particular wireless protocol.

It should be appreciated that one embodiment of the invention is directed to use with a computing device having programmable circuitry (e.g., the front end hardware 202 and the SDR drivers 216) that is programmable by control instructions to generate and/or receive signals according to a wireless protocol. Again, this programmable circuitry can take any suitable form and include any collection of directly programmable circuitry (e.g., a programmable processor) and circuitry that interacts with directly programmable circuitry to enable communication according to a wireless protocol.

It should be appreciated that the embodiments of the present invention described herein are not limited to being practiced with the type of computing device illustrated in FIG. 4, and that embodiments of the invention can be practiced with any suitable computing device. The front end 202 and adapters 204-208 may be implemented as any suitable hardware, software, or combination thereof, and may be implemented as a single unit or multiple units. Similarly, computer-readable media 212 may be implemented as any medium or combination of media for storing data and instructions for access by a processing device.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for accessing a spectrum, the method comprising:
a) sending a request for access to a spectrum;
b) receiving an offer to access a spectrum, said access being based on one or more constraints; and
c) accepting, rejecting or countering the offer.

2. The method of claim 1, wherein the method is performed, at least in part, in software defined radio.

3. The method of claim 1, wherein said one or more constraints comprises at least one of a length of time use of the spectrum is permitted and an amount of acceptable spectrum interference.

4. The method of claim 3, wherein access to the spectrum based on a length of time use of the spectrum is permitted requires an exchange of consideration.

5. The method of claim 1, wherein sending a request for access to a spectrum comprises sending at least one parameter.

6. The method of claim 1, wherein the at least one parameter comprises at least one of: required bandwidth; set of preferred bands; and desired mask properties.

7. The method of claim 6, wherein the at least one parameter comprises at least one of: a request for an incentive-based auction wherein additional parameters include at least one of a time of usage and a duration of usage; and a request for an interference-based auction wherein additional parameters include at least one of a location and an amount of acceptable spectrum interference.

8. The method of claim 1, wherein sending a request for access to a spectrum and receiving an offer to access a spectrum comprises first receiving a broadcast of an offering of bids to access spectrum.

9. A computer-readable medium having computer-executable instructions, the computer-executable instructions being adapted to perform, when executed, the method of claim 1.

10. A method for providing access to a spectrum, the method comprising:
a) receiving a request for access to a spectrum from a user;
b) determining a suitable spectrum to offer;
c) sending an auction bid to a spectrum provider;
d) receiving an offer to access a spectrum from the spectrum provider, said access being based on one or more constraints;
e) sending the offer to the user; and
f) receiving an acceptance, rejection or counter-offer from the user.

11. The method of claim 10, wherein sending an auction bid to a spectrum provider comprises sending subsequent auction bids.

12. The method of claim 10, wherein sending an auction bid to a spectrum provider comprises sending the auction bid to a plurality of spectrum providers.

13. The method of claim 10, wherein said one or more constraints comprises at least one of a length of time use of the spectrum is permitted and an amount of acceptable spectrum interference.

14. The method of claim 13, wherein access to the spectrum based on a length of time use of the spectrum is permitted requires an exchange of consideration.

15. The method of claim 10, further comprising receiving a packet at the requested band and determining an amount interference.

16. The method of claim 10, wherein the at least one parameter comprises at least one of: required bandwidth; set of preferred bands; and desired mask properties.

17. The method of claim 16, wherein the at least one parameter comprises at least one of: a request for an incentive-based auction wherein additional parameters include at least one of a time of usage and a duration of usage; and a request for an interference-based auction wherein additional parameters include at least one of a location and an amount of acceptable spectrum interference.

18. The method of claim 10, wherein receiving a request for access to a spectrum from a user comprises first sending a broadcast of an offering of bids to access spectrum.

19. An apparatus for operating a wireless computing device, the apparatus comprising:
a first circuit configurable to send a request for access to a spectrum;
a second circuit configurable to receive an offer to access a spectrum, said access being based on one or more constraints; and
a processor configurable to process an acceptance, a rejection or a counter-offer.

20. The apparatus of claim 19, further comprising a software defined radio operable to transmit and receive signals within the spectrum, and wherein the processor is configured to operate within the one or more constraints.
